(19) United States
(12) Patent Application Publication
(10) Pub. No.: US 2022/0290614 A1
(43) Pub. Date: Sep. 15, 2022

(54) AIRCRAFT HAVING AN ENGINE AND A COOLING SYSTEM

(71) Applicant: Airbus Operations SAS, Toulouse (FR)

(72) Inventors: Maxime ZEBIAN, TOULOUSE (FR); Davy BOURGALET, TOULOUSE (FR)

(21) Appl. No.: 17/686,759

(22) Filed: Mar. 4, 2022

(30) Foreign Application Priority Data
Mar. 10, 2021 (FR) 2102348

(51) Int. Cl. F02C 7/224; F02C 7/22; F02C 7/232; F02C 6/08

(52) U.S. Cl. CPC F02C 7/224; F02C 7/222; F02C 7/232; F02C 6/08; F05D 2220/323; F05D 2260/213; F05D 2260/232; F05D 2260/606

(57) ABSTRACT

An aircraft having an engine, a tank, devices to be heated, air intakes, a heat exchanger, a pipe connecting the air intakes and the devices to be heated by passing through the heat exchanger, a fuel pipe connected between the tank and the combustion chamber of the engine, and an air pipe which feeds the heat exchanger from the fan duct. The aircraft has an additional heat exchanger installed on the pipe between the heat exchanger and the air intakes, and a diversion pipe that passes through the additional heat exchanger and is connected at each end to the fuel pipe. The use of the fuel to cool the air makes it possible to use a smaller and therefore less bulky heat exchanger.

### CROSS-REFERENCES TO RELATED APPLICATIONS

This application claims the benefit of the French patent application No. 2102348 filed on Mar. 10, 2021, the entire disclosures of which are incorporated herein by way of reference.

### FIELD OF THE INVENTION

The present invention relates to an aircraft having an engine and a cooling system.

### BACKGROUND OF THE INVENTION

An aircraft conventionally has a fuselage which delimits a cabin for passengers and crew. In the description, the term “cabin” includes not only the cabin in which the passengers are seated, but also the cockpit. The aircraft also has de-icing means for example for de-icing the wings. The cabin and the de-icing means constitute devices to be heated.

The aircraft also has at least one turbojet engine which makes it possible to drive the aircraft and which is fed with aviation fuel from a tank.

The aircraft also has an air conditioning system which draws in hot air at the turbojet engine, which regulates the temperature of the air thus drawn in and which sends the air thus regulated to the devices to be heated, namely the cabin, in order to regulate the temperature thereof, and the de-icing means.

The conditioning system thus has heat exchangers, filters, pipes, valves, etc. and it takes hot air from the turbojet engine to treat it and send it to its destination, in particular towards the devices to be heated.

FIG. 3 is a schematic depiction of such an aircraft 300 from the prior art. The aircraft 300 has a turbojet engine 301 which incorporates, among other things, a gearbox, and which also has a fan disposed in a fan duct and intended to generate an air flow in the turbojet engine 301 in a direction of movement of the air in the turbojet engine 301, where, in a known manner, the air flow then moves downstream of the fan in a primary duct or in a secondary duct of the turbojet engine 301.

The turbojet engine 301 also has an engine compressor which has a low-pressure compressor downstream of the fan and a high-pressure compressor downstream of the low-pressure compressor, and an engine turbine which has a high-pressure turbine downstream of the high-pressure compressor, and a low-pressure turbine downstream of the high-pressure turbine.

The air blown by the fan and passing through the primary duct passes successively through the low-pressure compressor, the high-pressure compressor, the high-pressure turbine, and the low-pressure turbine, and is then ejected towards the outside. Between the high-pressure compressor and the high-pressure turbine, the air passes through a combustion chamber in which it is mixed with fuel in order to burn the latter.

The high-pressure compressor has multiple compression stages in which the pressure increases, from upstream to downstream in the direction of movement, from a low pressure in the first stage to a high pressure in the last stage, passing through intermediate pressures in the intermediate stages.

The aircraft 300 also has devices 304 to be heated (cabin, de-icing means) and an air conditioning system. The air conditioning system has a first heat exchanger 302, a first air intake 307 intended to draw, from the high-pressure compressor, air at low pressure or at intermediate pressure, and a second air intake 308 intended to draw, from the high-pressure compressor, air at high pressure.

The air conditioning system also has a first pipe 310 which passes through the first heat exchanger 302 and feeds the devices 304 to be heated downstream of the first heat exchanger 302. Upstream of the first heat exchanger 302, the first pipe 310 is divided into two sub-pipes, one of which is fluidically connected to the first air intake 307 and the other of which is fluidically connected to the second air intake 308. Each sub-pipe is in this case equipped with a valve 312, 314 which makes it possible to regulate the passage of the air coming from each air intake 307, 308 depending on the requirements of the aircraft 300, and to this end, the aircraft 300 has a control unit intended to command the valves 312 and 314 to open and close.

The air conditioning system also has a first air pipe 316 which feeds the first heat exchanger 302 with air drawn from the fan duct. To regulate the flow rate of air entering the first heat exchanger 302, the first air pipe 316 is equipped, at the inlet of said first heat exchanger 302, with a valve 317 installed on the first air pipe 316 and commanded to open and close by the control unit.

Thus, the hot air drawn in at the air intakes 307 and 308 is cooled on passing through the first heat exchanger 302 by the cold air drawn in at the fan duct, which is then heated and released to the outside, while the cooled air is directed towards the devices 304 to be heated through the first pipe 310.

In order for the turbojet engine 301 to be cooled, the aircraft 300 has a second heat exchanger 318 which is intended to effect heat exchange between an air flow coming from the fan duct and a flow of oil coming from the turbojet engine 301.

To this end, the aircraft 300 has a second air pipe 320 which draws air from the fan duct in order to feed the second heat exchanger 318, and a first oil circuit 322 that draws oil from the turbojet engine 301 and reinjects this oil after it has passed through the second heat exchanger 318.

Thus, the hot oil drawn in at the turbojet engine 301 is cooled on passing through the second heat exchanger 318 by the cold air drawn in at the fan duct, which is then heated and released towards the outside, while the cooled oil is directed towards the turbojet engine 301.

The aircraft 300 has a fuel tank 108 which makes it possible to store aviation fuel and a fuel pipe 326 which feeds the combustion chamber of the turbojet engine 301. A pump 303 is arranged at the outlet of the fuel tank 108 to drive the fuel into the fuel pipe 326.

In order to ensure better cooling of the turbojet engine 301, the aircraft 300 has a third heat exchanger 328 which is intended to effect heat exchange between the fuel coming from the fuel tank 108 and a flow of oil coming from the turbojet engine 301.

To this end, the fuel pipe 326 draws fuel from the fuel tank 108 to feed the third heat exchanger 328, and a second oil circuit 330 draws oil from the turbojet engine 301 and reinjects this oil after it has passed through the third heat exchanger 328.

Thus, the hot oil drawn in at the turbojet engine 301 is cooled on passing through the third heat exchanger 328 by the fuel drawn from the fuel tank 108, which is then heated and conveyed towards the combustion chamber, while the cooled oil is directed towards the turbojet engine 301.

The aircraft 300 also has an electric generator 332 which generates an electric current for supplying the aircraft 300. To ensure the cooling of the electric generator 332, the aircraft 300 has a fourth heat exchanger 334 which is intended to effect heat exchange between the fuel coming from the fuel tank 108 and a flow of oil coming from the electric generator 332.

To this end, the fuel pipe 326 draws fuel from the fuel tank 108 to feed the fourth heat exchanger 334, and a third oil circuit 336 draws oil from the electric generator 332 and reinjects this oil after it has passed through the fourth heat exchanger 334.

Thus, the hot oil drawn in at the electric generator 332 is cooled on passing through the fourth heat exchanger 334 by the fuel drawn from the fuel tank 108, which is then heated and conveyed towards the combustion chamber, while the cooled oil is directed towards the electric generator 332.

In the embodiment presented here, the fourth heat exchanger 334 is upstream of the third heat exchanger 328 on the fuel pipe 326, and the latter thus passes successively through the fourth heat exchanger 334 and then the third heat exchanger 328 before reaching the combustion chamber.

The aircraft 300 also has a return pipe 338 fluidically connected between the fuel pipe 326 and the fuel tank 108 at a valve 340 installed on the fuel pipe 326 between the fourth heat exchanger 334 and the third heat exchanger 328 and commanded to open and close by the control unit. Thus, the fuel can cool the oil from the electric generator 332 and return into the fuel tank 108 without fuel being sent towards the combustion chamber.

Although such an installation performs well, it is necessary to use a first heat exchanger with large dimensions to ensure sufficient cooling. It is therefore necessary to find a different installation in which the first heat exchanger is smaller and therefore less bulky and less heavy.

### SUMMARY OF THE INVENTION

An object of the present invention is to provide an aircraft having an engine and a cooling system which makes it possible to use a smaller heat exchanger than in the prior art.

To this end, an aircraft is proposed having:
an engine having a high-pressure compressor with multiple compression stages, a combustion chamber, and a fan duct,
a fuel tank containing fuel,
devices to be heated,
a first air intake intended to draw, from the high-pressure compressor, air at a low pressure or at an intermediate pressure, a second air intake intended to draw, from the high-pressure compressor, air at a high pressure,
a first heat exchanger,
a first pipe which passes through the first heat exchanger and feeds the devices to be heated downstream of the first heat exchanger, wherein, upstream of the first heat exchanger, the first pipe is divided into two sub-pipes, one of which is fluidically connected to the first air intake and the other of which is fluidically connected to the second air intake,
a fuel pipe fluidically connected between the fuel tank and the combustion chamber of the engine, and
a first air pipe which feeds the first heat exchanger with air drawn from the fan duct,
an additional heat exchanger installed on the first pipe upstream of the first heat exchanger and downstream of the air intakes,
a diversion pipe, a first branch of which is fluidically connected between the fuel pipe and an inlet of the additional heat exchanger and a second branch of which is fluidically connected between an outlet of the additional heat exchanger and the fuel pipe, and
a bypass pipe fitted on the first pipe and fluidically connected on either side of the first heat exchanger, and a valve fitted on the bypass pipe and commanded to open and close.

The use of the fuel to cool the air makes it possible to use a smaller and therefore less bulky first heat exchanger.

Advantageously, the connection of the first branch to the fuel pipe is upstream of the connection of the second branch to the fuel pipe in relation to the direction of flow of the fuel in the fuel pipe.

Advantageously, each branch of the diversion pipe is equipped with a valve installed on said branch and commanded to open and close.

Advantageously, between the connections of the diversion pipe to the fuel pipe, the fuel pipe is equipped with a valve commanded to open and close.

### BRIEF DESCRIPTION OF THE DRAWINGS

The abovementioned features of the invention, along with others, will become more clearly apparent from reading the following description of an exemplary embodiment, said description being given with reference to the appended drawings, in which:

FIG. 1 is a side view of an aircraft according to the invention,

FIG. 2 is a schematic depiction of an aircraft according to the invention, and

FIG. 3 is a schematic depiction of an aircraft of the prior art.

### DETAILED DESCRIPTION OF THE PREFERRED EMBODIMENTS

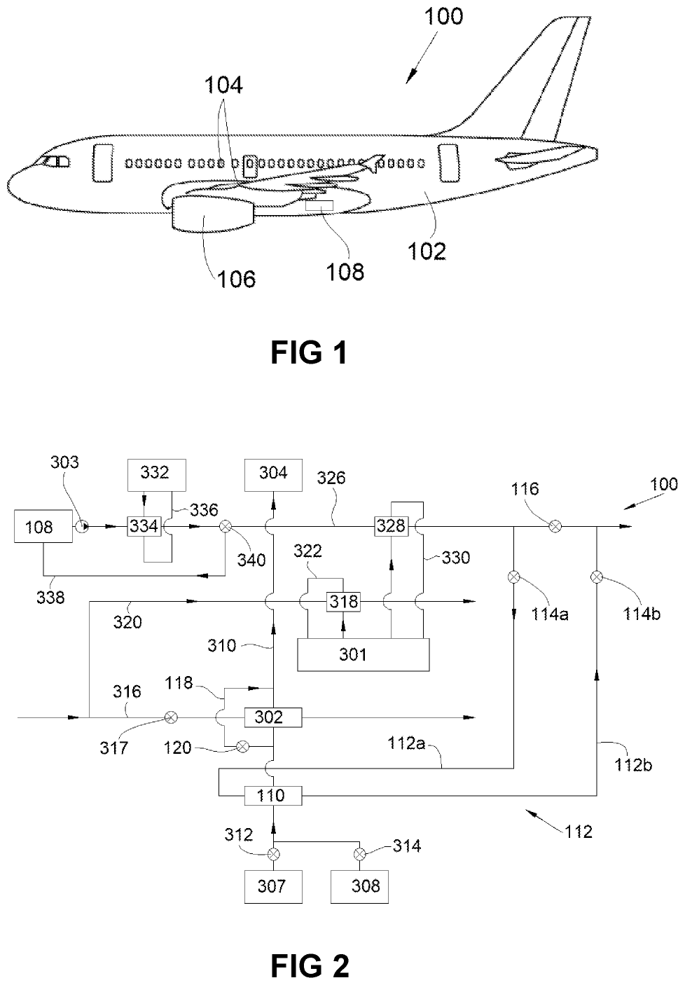

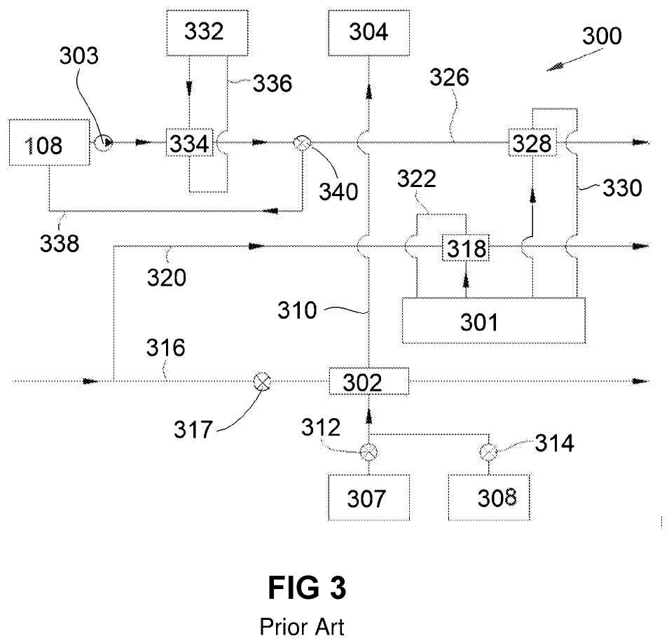

FIG. 1 schematically shows an aircraft 100 according to the invention, which has a fuselage 102 which internally delimits a cabin including the space in which the passengers are seated and the cockpit. The aircraft 100 also has de-icing means, for example for de-icing the wings. The cabin and the de-icing means constitute devices 104 to be heated. Of course, other elements of the aircraft 100 can be integrated in these devices 104 to be heated.

The aircraft 100 also has at least one propulsion system 106 comprising an engine 301 incorporating, among other things, a gearbox, and taking the form of a turbojet engine or a turboprop engine that operates with a fuel such as aviation fuel or dihydrogen which is stored in a fuel tank 108 disposed, for example, in the wings.

In the following description, the functional elements that are common to the embodiment according to the invention and to the embodiment of the prior art bear the same references.

FIG. 2 is a schematic depiction of an aircraft 100 according to the invention.

As in the case of the prior art, the aircraft 100 has an air conditioning system which draws in hot air at the engine 301, which regulates the temperature of the air thus drawn in and sends the air thus regulated towards the devices 304 to be heated, namely the cabin, in order to regulate the temperature thereof, and the de-icing means.

The engine 301 also has a fan disposed in a fan duct and configured to generate an air flow in the turbojet engine 301 and an engine compressor with a low-pressure compressor downstream of the fan and a high-pressure compressor downstream of the low-pressure compressor, and an engine turbine with a high-pressure turbine downstream of the high-pressure compressor, and a low-pressure turbine downstream of the high-pressure turbine, and also a combustion chamber between the high-pressure compressor and the high-pressure turbine, where the fuel is mixed with the air in order to be burned there.

The high-pressure compressor has multiple compression stages where the pressure increases, from upstream to downstream in the direction of movement, from a low pressure at the first stage, to a high pressure at the last stage, passing through intermediate pressures in the intermediate stages.

The air conditioning system has a first heat exchanger 302, a first air intake 307 configured to draw, from the high-pressure compressor, air at low pressure or intermediate pressure, and a second air intake 308 configured to draw, from the high-pressure compressor, air at high pressure.

The air conditioning system also has a first pipe 310 which passes through the first heat exchanger 302 and feeds the devices 304 to be heated downstream of the first heat exchanger 302 in relation to the direction of the air flow in the first pipe 310. Upstream of the first heat exchanger 302 in relation to the direction of the air flow in the first pipe 310, the first pipe 310 is divided into two sub-pipes, one of which is fluidically connected to the first air intake 307 and the other of which is fluidically connected to the second air intake 308. Each sub-pipe is, in this case, equipped with a valve 312, 314 which makes it possible to regulate the passage of the air coming from each air intake 307, 308 depending on the requirements of the aircraft 100, and to this end, the aircraft 100 has a control unit or controller configured to command the valves 312 and 314 to open and close.

The air conditioning system also has a first air pipe 316 which feeds the first heat exchanger 302 with air drawn from the fan duct and, after it has passed through the first heat exchanger 302, releases the air to the outside.

Thus, the hot air drawn in at the air intakes 307 and 308 is cooled on passing through the first heat exchanger 302 by the cold air drawn in at the fan duct, which is then heated and released towards the outside, while the cooled air is directed towards the devices 304 to be heated through the first pipe 310.

In order to ensure that the turbojet engine 301 is cooled, the aircraft 100 has a second heat exchanger 318, which is configured to effect heat exchange between an air flow coming from the fan duct and a flow of oil coming from the turbojet engine 301.

To this end, the aircraft 100 has a second air pipe 320, which draws air from the fan duct in order to feed the second heat exchanger 318, and a first oil circuit 322 that draws oil from the turbojet engine 301 and reinjects this oil after it has passed through the second heat exchanger 318.

Thus, the hot oil drawn in at the turbojet engine 301 is cooled on passing through the second heat exchanger 318 by the cold air drawn in at the fan duct, which is then heated and released towards the outside, while the cooled oil is directed towards the turbojet engine 301.

The aircraft 100 has a fuel pipe 326, which feeds the combustion chamber of the turbojet engine 301 from the fuel tank 108. A pump 303 is arranged at the outlet of the fuel tank 108 to drive the fuel into the fuel pipe 326.

In order to ensure better cooling of the turbojet engine 301, the aircraft 100 has a third heat exchanger 328, which is configured to effect heat exchange between the fuel coming from the fuel tank 108 and a flow of oil coming from the turbojet engine 301.

To this end, the fuel pipe 326 draws fuel from the fuel tank 108 to feed the third heat exchanger 328, and a second oil circuit 330 draws oil from the turbojet engine 301 and reinjects this oil after it has passed through the third heat exchanger 328.

Thus, the hot oil drawn in at the turbojet engine 301 is cooled on passing through the third heat exchanger 328 by the fuel drawn from the fuel tank 108, which is then heated and conveyed towards the combustion chamber, while the cooled oil is directed towards the turbojet engine 301.

The aircraft 100 also has an electric generator 332 and, in order to ensure that the electric generator 332 is cooled, the aircraft 100 has a fourth heat exchanger 334, which is configured to effect heat exchange between the fuel coming from the fuel tank 108 and a flow of oil coming from the electric generator 332.

To this end, the fuel pipe 326 draws fuel from the fuel tank 108 in order to feed the fourth heat exchanger 334, and a third oil circuit 336 draws oil from the electric generator 332 and reinjects this oil after it has passed through the fourth heat exchanger 334.

Thus, the hot oil drawn in at the electric generator 332 is cooled on passing through the fourth heat exchanger 334 by the fuel drawn from the fuel tank 108, which is then heated and conveyed towards the combustion chamber, while the cooled oil is directed towards the electric generator 332.

In the embodiment presented here, the fourth heat exchanger 334 is upstream of the third heat exchanger 328 in relation to the direction of the flow of fuel in the fuel pipe 326, and the latter thus passes successively through the fourth heat exchanger 334 and then the third heat exchanger 328 before reaching the combustion chamber, although a different organization is possible.

The aircraft 100 also has a return pipe 338 fluidically connected between the fuel pipe 326 and the fuel tank 108 at a valve 340 installed on the fuel pipe 326 between the fourth heat exchanger 334 and the third heat exchanger 328 and commanded to open and close by the controller. Thus, the fuel can cool the oil from the electric generator 332 and return into the fuel tank 108 without the fuel being sent towards the combustion chamber.

The aircraft 100 also has an additional heat exchanger 110, which is installed on the first pipe 310 upstream of the first heat exchanger 302 and downstream of the air intakes 307 and 308 in relation to the direction of the air flow in the first pipe 310, that is to say, between the first heat exchanger 302 and the air intakes 307 and 308. Thus, the air coming from the air intakes 307 and 308 passes successively through the additional heat exchanger 110, and then the first heat exchanger 302 before reaching the devices 304 to be heated.

The aircraft 100 also has a diversion pipe 112, a first branch 112a of which is fluidically connected between the fuel pipe 326 and an inlet of the additional heat exchanger 110, and a second branch 112b of which is fluidically connected between an outlet of the additional heat exchanger 110 and the fuel pipe 326.

The connection of the first branch 112a to the fuel pipe 326 is upstream of the connection of the second branch 112b to the fuel pipe 326 in relation to the direction of flow of the fuel in the fuel pipe 326.

Thus, before passing through the first exchanger 302, the air coming from the air intakes 307 and 308 is cooled by passing through the additional heat exchanger 110, and before it is injected into the combustion chamber, the fuel is heated on passing through the additional heat exchanger 110, successively following the fuel pipe 326 from the fuel tank 108, the diversion pipe 112, passing successively through the first branch 112a, the additional heat exchanger 110, the second branch 112b, and returning into the fuel pipe 326 in order to reach the combustion chamber.

In the embodiment of the invention presented in FIG. 2, the connections of the diversion pipe 112 to the fuel pipe 326 are downstream of the third heat exchanger 328 and the fourth heat exchanger 334 in relation to the direction of the flow of fuel in the fuel pipe 326, but a different arrangement is possible.

The fitting of the additional heat exchanger 110 makes it possible to reduce the size of the first heat exchanger 302 compared with the one from the prior art, and therefore to have less bulk.

The temperature of the fuel passing through the additional heat exchanger 110 is lower than the temperature of the air passing through the first heat exchanger 302, thereby ensuring a greater drop in temperature of the air configured for the devices 304 to be heated. At the same time, the increase in the temperature of the fuel before its combustion makes it possible to increase its efficiency.

Moreover, the reduction in the quantity of air drawn from the fan duct in order to cool the air configured for the devices 304 to be heated allows an increase in the performance of the engine 301.

To make it easier to manage the quantity of fuel passing through the diversion pipe 112, each branch 112a-b of the diversion pipe 112 is equipped with a valve 114a-b installed on the branch 112a-b in question and commanded to open and close by the controller.

To improve the management of the quantity of fuel, between the connections of the diversion pipe 112 on the fuel pipe 326, the fuel pipe 326 is equipped with a valve 116 commanded to open and close by the controller.

When the drop in temperature of the air configured for the devices 304 to be heated is sufficient with only the additional heat exchanger 110, a bypass pipe 118 is fitted on the first pipe 310 and fluidically connected on either side of the first heat exchanger 302. A valve 120 is fitted on the bypass pipe 118 and is commanded to open and close by the controller.

To regulate the flow rate of air entering the first heat exchanger 302 and limit drawing in at the fan duct, the first air pipe 316 is equipped, at the inlet of said first heat exchanger 302, with a valve 317 installed on the first air pipe 316 and commanded to open and close by the controller.

Thus, when the valve 120 is closed, the air leaving the additional heat exchanger 110 passes through the first heat exchanger 302 in order to undergo greater cooling, and when the valve 120 is open, the air leaving the additional heat exchanger 110 flows directly towards the devices 304 to be heated, through the bypass pipe 18 and then the first pipe 310.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft comprising:
an engine having a high-pressure compressor with multiple compression stages, a combustion chamber and a fan duct,
a fuel tank containing fuel,
devices to be heated,
a first air intake configured to draw, from the high-pressure compressor, air at a low pressure or at an intermediate pressure, a second air intake configured to draw, from the high-pressure compressor, air at a high pressure,
a first heat exchanger,
a first pipe which passes through the first heat exchanger and feeds the devices to be heated downstream of the first heat exchanger, wherein, upstream of the first heat exchanger, the first pipe is divided into two sub-pipes, one of which is fluidically connected to the first air intake and the other of which is fluidically connected to the second air intake,
a fuel pipe fluidically connected between the fuel tank and the combustion chamber of the engine, and
a first air pipe which feeds the first heat exchanger with air drawn from the fan duct,
an additional heat exchanger installed on the first pipe upstream of the first heat exchanger and downstream of the first and second air intakes,
a diversion pipe, a first branch of which is fluidically connected between the fuel pipe and an inlet of the additional heat exchanger and a second branch of which is fluidically connected between an outlet of the additional heat exchanger and the fuel pipe, and
a bypass pipe fitted on the first pipe and fluidically connected on either side of the first heat exchanger, and a valve fitted on the bypass pipe and commanded to open and close.

2. The aircraft according to claim 1, wherein the fluidic connection of the first branch to the fuel pipe is upstream of the fluidic connection of the second branch to the fuel pipe in relation to the direction of flow of the fuel in the fuel pipe.

3. The aircraft according to claim 2, wherein each branch of the diversion pipe is equipped with a valve installed on said branch and commanded to open and close.

4. The aircraft according to claim 3, wherein, between the fluidic connections of the diversion pipe to the fuel pipe, the fuel pipe is equipped with a valve which is configured to open and close upon receipt of a command from a controller.
